(19) United States
(12) Patent Application Publication
(10) Pub. No.: US 2004/0148790 A1
(43) Pub. Date: Aug. 5, 2004

(54) Time alarm system in detecting scanner/step module tilt

(75) Inventors: Rong-Hau Hsueh, Jubei City (TW); Jaw-Lih Shyr, Hsinchu (TW); Wen-Hsong Wu, Taichung (TW)

Correspondence Address: GEORGE O. SAILE & ASSOCIATES, 28 DAVIS AVENUE, POUGHKEEPSIE, NY, 12603, US

(73) Assignee: Taiwan Semiconductor Manufacturing Company

(21) Appl. No.: 10/357,578

(22) Filed: Feb. 4, 2003

(51) Int. Cl. G01C 15/00

(52) U.S. Cl. 33/286

(57) ABSTRACT

A new method to detect module-to-module misalignment in a manufacturing apparatus is achieved. The method comprises providing a manufacturing apparatus comprising a first module and a second module. The first and second modules are initialized to an optimal alignment with respect to each other. Relative motion is detected in a first direction between the first and second modules. The relative motion indicates a loss of optimal alignment. A alarm is generated based on loss of optimal alignment. An apparatus is also achieved.

### BACKGROUND OF THE INVENTION

(1) Field of the Invention

The invention relates to a method to detect module misalignment in manufacturing equipment, and, more particularly, to a method to detect module tilt in a reticle exposure apparatus.

(2) Description of the Prior Art

Photolithography represents a critical area in the art of integrated circuit manufacturing. Photolithography comprises the processing steps of forming a photosensitive material on the surface of an integrated circuit wafer, selectively exposing this material to actinic light through a mask or reticle, and then removing either exposed or unexposed material. Following these steps, the remaining photosensitive material, typically called photoresist, contains a positive or negative image either of the reticle pattern. In this way, the reticle pattern is transferred to the wafer. This patterned resist can then be used to mask an etching step or to mask an ion implanting step as dictated by the processing sequence.

An important feature of the photolithography process is the machine used to expose the wafer to light through the reticle. This machine is called a mask aligner or a reticle exposure apparatus. Referring now to FIG. 1, a reticle exposure apparatus 10 is shown in a greatly simplified, cross sectional illustration. An integrated circuit wafer 54 is supported on a wafer stage 50. A light source 34 generates light 58 of a specified wavelength. For example, 248 nanometer light 58 may be generated. The exposure light 58 is optically routed using mirrors 38. The repositioned light 58 passes through the reticle or mask 43 and is then focused or perhaps magnified using a lens system 46. The light 58 that passes through the mask 43 is allowed to strike the wafer 54 for a specified amount of time, called an exposure time. Many arrangements of light source 34, mirrors 38, lenses 46 and masks 43 may be used. For example, the reticle exposure apparatus 10 may be configured as a scanner or as a stepper.

Of particular importance to the present invention is the fact that the reticle exposure apparatus 10 comprises two modules, the top module 20 and the bottom module 30. In this configuration, the bottom module 30 contains the light path origination 34 and termination 54 points. The top module contains the middle medium 42 and mirrors 38 for the light path. Such an arrangement optimizes the area and height of the apparatus to the available area and height found in the integrated circuit foundry. Further, this arrangement may provide excellent accessibility for maintenance. The top module 20 can be removed, relatively easily, from the bottom module to thereby provide improved access to the system in either module.

Referring now to FIG. 2, a particular problem with the modular reticle exposure apparatus 10 is shown. During machine setup, great care is taken to insure that the light beam 58 from the top module 20 is perpendicular to the lens system of the bottom module 30. In this respect, the top module 20 is adjusted to achieve the optimal tilt 63 with respect to the bottom module 30 to thereby optimize the light beam 58 to lens angle. The setup optimization can be verified by running a telecentricity test on the reticle exposure apparatus 10 prior to exposing any production material. The optimized setup on the apparatus is then mechanically fixed.

However, it is found that the optimized relationship between the modules 20 and 30 can be lost during the exposure of production lots. In particular, mechanical vibration, mechanical drifting, or even earthquakes can cause a tilt 63 in the optimal position between the top module 20 and the bottom module 30. This tilt error 63 will cause the light beam 58 to not be perpendicular with respect to the lens 46. If this tilt 63 condition exists during the exposure of a wafer 54, then it will cause an X/Y critical dimension (CD) bias in the exposed image on the wafer. This X/Y CD bias can be detected by optical inspection of the wafers.

As described above, it is possible to run the telecentricity test to verify that the light beam 58 is perpendicular with respect to the lens 46. However, this test cannot be run in real time, during the exposure step. Therefore, if the tilt 63 occurs during a wafer exposure, it will not be detected until optical inspection. Typically, a production lot or several production lots of wafers may be run through the exposure apparatus 10 before the tilt problem is detected. This represents a significant re-work or scrap problem.

Several prior art inventions relate to lithography systems used in integrated circuit manufacturing. U.S. Pat. No. 5,917,590 to Greve describes an optical inspection method and device. The invention facilitates inspection of two opposite surfaces such as the top and bottom surfaces of an optical mask. U.S. Pat. No. 6,244,717 B1 to Dinger teaches an apparatus and a method for reduction objective, ultraviolet lithography. U.S. Pat. No. 6,259,508 B1 to Shigematsu discloses a projection optical system and exposure apparatus and a method of use.

### SUMMARY OF THE INVENTION

A principal object of the present invention is to provide an effective and very manufacturable method to detect module misalignment in manufacturing equipment.

A further object of the present invention is to provide a method to detect movement of pre-aligned modules of a reticle exposure apparatus used for integrated circuit lithography.

A yet further object of the present invention is to eliminate CD bias effects in exposed integrated circuit wafers due to module-to-module misalignment.

A yet further object of the present invention is to detect movement using a switch mechanism.

A yet further object of the present invention is to detect movement in multiple directions.

A yet further object of the present invention is to provide an alarm mechanism based on the status of the misalignment detector.

In accordance with the objects of this invention, a method to detect module-to-module misalignment in a manufacturing apparatus is achieved. The method comprises providing a manufacturing apparatus comprising a first module and a second module. The first and second modules are initialized to an optimal alignment with respect to each other. Relative motion is detected in a first direction between the first and second modules. The relative motion indicates a loss of optimal alignment. An alarm is generated based on loss of optimal alignment.

Also in accordance with the objects of this invention, a multiple module manufacturing apparatus capable of detecting module-to-module misalignment is achieved. The apparatus comprises a first module and a second module. The first and second modules are initialized to an optimal alignment with respect to each other. A switch is included that is capable of detecting relative motion in a first direction between the first and second modules. The relative motion indicates a loss of optimal alignment. A means to generate an alarm is based on loss of optimal alignment.

### BRIEF DESCRIPTION OF THE DRAWINGS

In the accompanying drawings forming a material part of this description, there is shown:

FIG. 1 illustrates a multiple-module, reticle exposure system shown in a simplified cross-section.

FIG. 2 illustrates the problem of module-to-module tilt in a reticle exposure apparatus.

FIG. 3 illustrates a preferred embodiment of the apparatus of the present invention.

FIG. 4 illustrates a preferred embodiment of the method of the present invention.

FIG. 5 illustrates a preferred embodiment of the present invention using a mercury switch.

FIG. 6 illustrates a preferred embodiment of the present invention with two detectors.

FIG. 7 illustrates a preferred embodiment of an alarm circuit.

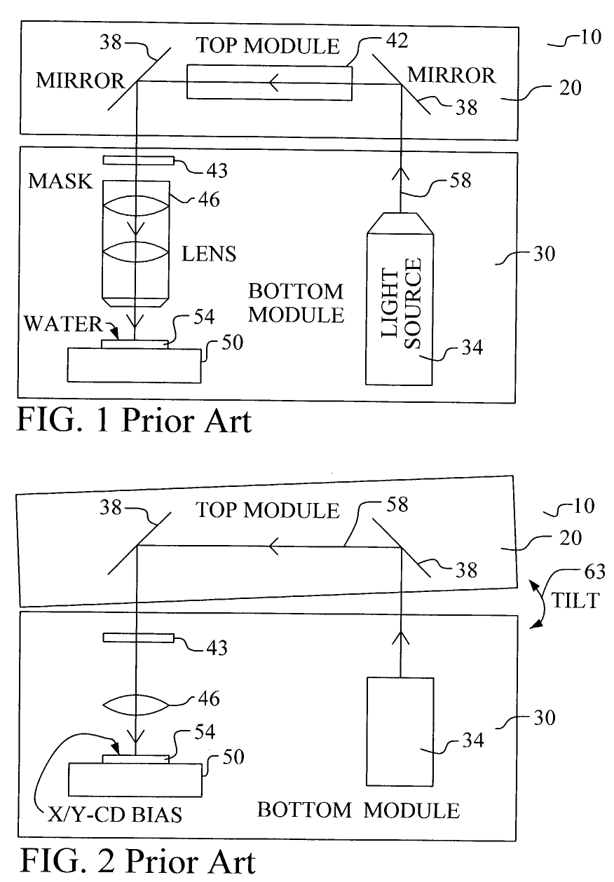

### DESCRIPTION OF THE PREFERRED EMBODIMENTS

The preferred embodiments of the present invention disclose a method to detect module-to-module misalignment in a manufacturing apparatus. Detection switches are use to provide real-time feedback regarding module alignment. A multiple module manufacturing apparatus capable of detecting module-to-module misalignment is also achieved. It should be clear to those experienced in the art that the present invention can be applied and extended without deviating from the scope of the present invention.

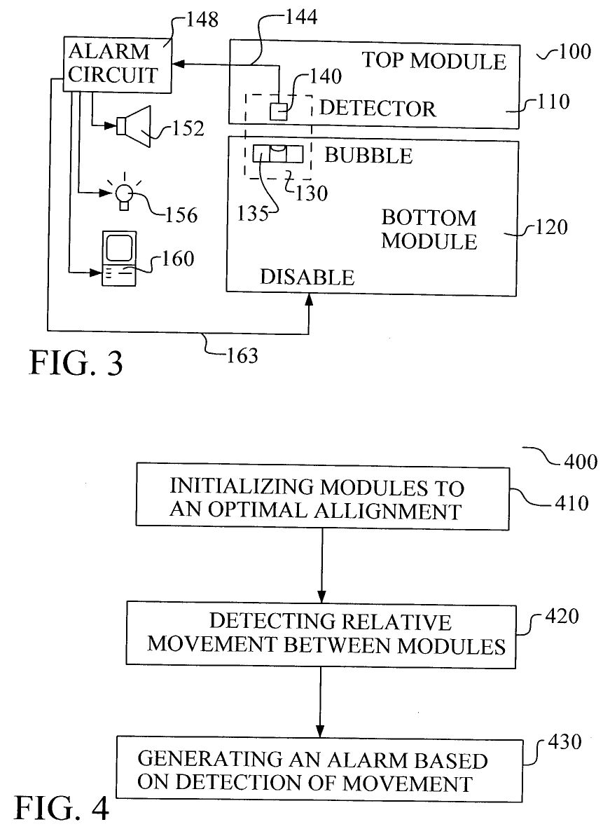

Referring now to FIG. 3, the preferred embodiment of the present invention is illustrated. Several important features of the present invention are shown and discussed below. A multiple module manufacturing apparatus 100 is shown. The apparatus preferably comprises a reticle exposure apparatus as discussed above. However, the apparatus may comprise any manufacturing apparatus having two or more modules 110 and 120 wherein an optimal alignment between the modules must be maintained.

In the preferred embodiment, the reticle exposure apparatus 100 comprises a top module 110 and a bottom module 120. The apparatus 100 may further comprise additional modules. These additional modules may also require optimal alignments. In that case, the optimal alignments may be maintained using the teachings of the present invention. In the preferred embodiment, the modules comprise a top module 110 overlying a bottom module 120. In general, the modules may be in any orientation with respect to each other.

As an important feature, a switch 130 is included in the apparatus 100. The switch 130 is capable of detecting relative motion between the top module 110 and the bottom module 120. The switch mechanism 130 is fixably attached to the top module 110 and to the bottom module 120 such that relative movements between the modules will cause a relative movement to the components 140 and 135 of the switch 130.

Prior to activating the switch mechanism 130, the top and bottom modules 110 and 120 are optimally aligned. This alignment preferably comprises achieving telecentricity wherein the exposure light beam is made perpendicular to the lens as described in the prior art. However, any other critical parameter may be used to demonstrate optimal alignment between the top module 110 and the bottom module 120. The optimal alignment is determined and the modules 110 and 120 are fixably coupled in this orientation. At this point, the switch mechanism 130 can be initialized such that the switch components are in the aligned state.

For example, a first preferred embodiment of the switch mechanism 130 is a bubble 135 and detector 140 system as shown. In a bubble 135 and detector system 140, the motion detecting switch is coupled to one of the modules, in this case the top module 110. The bubble unit 135 is coupled to the other module, in this case the bottom module 120. Any relative movement between the modules 110 and 120, such as mechanical shift due to vibration or earthquake, will cause the detector 140 to trip. The tripping of the detector 140 is defined as a movement away from the optimal alignment of the top and bottom modules 110 and 120.

The signal from the detector 140 is coupled to an alarm circuit 148. The alarm circuit 148 comprises signal generating or conditioning circuits and an output or a plurality of outputs. In the example shown, the alarm circuit 148 is shown to provide several means to notify the operator of a loss of alignment. The alarm circuit 148 may provide a noise output to a speaker 152, such as a buzzer. The alarm circuit 148 may control a light or series of lights to show the state of the alignment switch 130. The alarm circuit 148 may generate an electronic notification 160 such as a data stream or an email message or an electronic beeper signal. Finally, the alarm circuit 148 may generate a control signal to feedback to the apparatus 100. In this way, the alarm circuit 148 can disable further processing of product in the apparatus anytime the circuit 148 detects a loss of alignment.

The novel apparatus of the present invention will detect a misalignment between the modules 110 and 120 in real time. Because of this feature, the apparatus will detect the misalignment at any time before, during, or after a production run. Therefore, production material is not subject to processing in the apparatus 100 during a misalignment. If the apparatus 100 is a reticle exposure apparatus, as discussed above in the prior art review, then the X/Y CD bias condition can be eliminated or limited to very few wafers. A maintenance call can be made to re-setup the apparatus 100 to the proper alignment before running any more product. These features will reduce scrap and rework as well as improve the quality of equipment maintenance by clearly and immediately indicating that a misalignment has occurred.

Referring now to FIG. 4, the preferred embodiment of the method of the present invention is illustrated. The method to detect module-to-module misalignment in a manufacturing apparatus comprises, first, initializing the first and second modules to an optimal alignment with respect to each other, in step 410. Second, relative motion is detected in a first direction between the first and second modules in step 420. The presence of this relative motion indicates a loss of optimal alignment. Finally, an alarm is generated based on loss of optimal alignment in step 430.

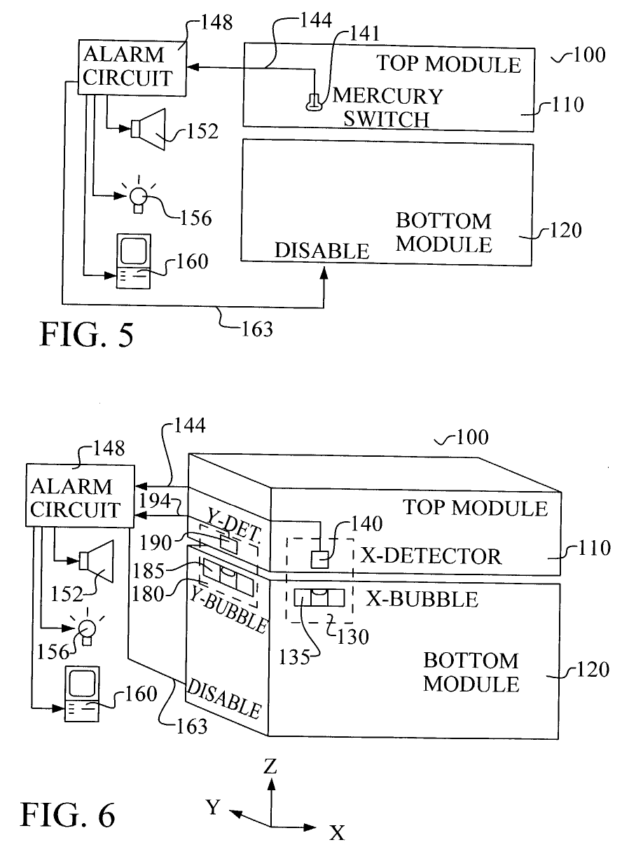

Referring now to FIG. 5, the preferred embodiment of the apparatus 100 of the present invention is illustrated using an alternative switch 141. In this case, a mercury switch 141 is used. The mercury switch 141 uses liquid mercury to form a connection between two terminals. The mercury switch 141 is fixably coupled to either of the modules 110 and 120. In the preferred embodiment, the switch 141 is fixably coupled to the top module 110 after the top module 110 and the bottom module 120 are optimally aligned. Any movement of the top module 110 will cause the mercury switch 141 to open due to movement of the liquid mercury. The alarm circuit 148 will detect the switch opening and signal an alarm using any of the methods 152, 156, 160, and 163, described earlier.

Referring now to FIG. 6, the preferred embodiment of the present invention is shown with an additional feature. A second switch mechanism 180 is added to the multiple-module apparatus 100. In this configuration, a first switch 130 is used for sensing tilt along the X-axis. As such, the first switch 130 comprises an X-detector 140 and an X-bubble 135. A second switch 180 is added to sense tilt along the Y-axis. This second switch 180 comprises a Y-detector 190 and a Y-bubble 185. Preferably, the X-switch 130 and the Y-switch 180 are fixably coupled to the modules 110 and 120 at 90-degree angles with respect to each other. Any movement of the modules 110 and 120 in any direction can then be sensed.

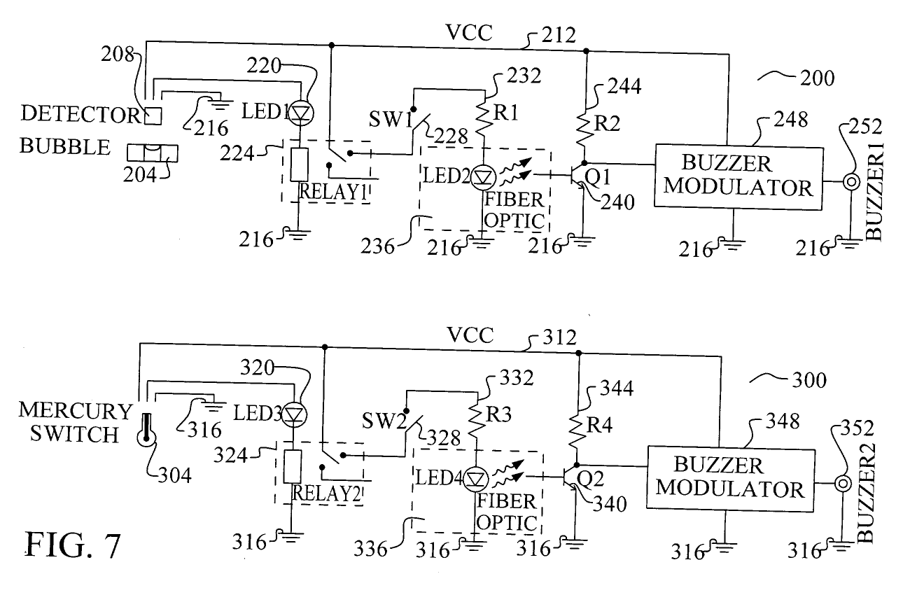

Referring now to FIG. 7, preferred embodiments of alarm circuits 200 and 300 are illustrated. In the topmost circuit 200, a bubble 204 and detector 208 switch is used. Current flows through LED1 220 when the switch is tripped. LED1 220 is lit to provide a visual indicator of motion detection. Further, RELAY1 224 sources current to LED2 in a fiber optic link 236. Bipolar transistor Q1 240 is turned ON to drive a buzzer modulator circuit 248, as is well known in the art. In this case, the output mode for the alarm is a buzzer BUZZER1 252. The bottommost circuit 300 works in similar fashion. However, in this case, a mercury switch 304 is shown as the input device.

The advantages of the present invention may now be summarized. An effective and very manufacturable method to detect module misalignment in manufacturing equipment is achieved. A method to detect movement of pre-aligned modules of a reticle exposure apparatus used for integrated circuit lithography is achieved. The method eliminates CD bias effects in exposed integrated circuit wafers due to module-to-module misalignment. Movement is detected using a switch mechanism. Movement may be detected in multiple directions using multiple switches. An alarm mechanism is based on the status of the misalignment detector.

As shown in the preferred embodiments, the novel method and apparatus of the present invention provides an effective and manufacturable alternative to the prior art.

1. A method to detect module-to-module misalignment in a manufacturing apparatus comprising:
providing a manufacturing apparatus comprising a first module and a second module
initializing an optimal alignment between said first and second modules;
detecting relative motion in a first direction between said first and second modules wherein said relative motion indicates a loss of optimal alignment; and
generating an alarm is said optimal alignment lost.

2. The method according to claim 1 wherein said apparatus comprises a reticle exposure apparatus for use in the manufacture of an integrated circuit device.

3. The method according to claim 1 wherein said step of detecting uses a bubble level mechanically coupled to one of said first and second modules and a motion detector coupled to the other of said first and second modules.

4. The method according to claim 1 wherein said step of detecting uses a mercury switch mechanically coupled to either of said first and second modules.

5. The method according to claim 1 wherein said alarm comprises stopping said manufacturing apparatus.

6. The method according to claim 1 wherein said alarm comprises a light.

7. The method according to claim 1 wherein said alarm comprises a noise.

8. The method according to claim 1 wherein said alarm comprises an electronic notification.

9. The method according to claim 1 further comprising detecting relative motion between said first and second modules in a second direction wherein said relative motion indicates a loss of optimal alignment.

10. The method according to claim 9 wherein said second direction is perpendicular to said first direction.

11. A method to detect module-to-module misalignment in a manufacturing apparatus comprising:
providing a reticle exposure apparatus for use in the manufacture of an integrated circuit device comprising a first module and a second module
initializing an optimal alignment between said first and second modules;
detecting relative motion between said first and second modules in a first direction;
detecting relative motion between said first and second modules in a second direction wherein said either of said relative motions in said first and second directions indicates a loss of optimal alignment; and
generating an alarm based on the status of said steps of detecting.

12. The method according to claim 11 wherein each of said steps of detecting uses a bubble level mechanically coupled to one of said first and second modules and a motion detector coupled to the other of said first and second modules.

13. The method according to claim 11 wherein each of said steps of detecting uses a mercury switch mechanically coupled to either of said first and second modules.

14. The method according to claim 11 wherein said first direction is perpendicular to said second direction.

15. The method according to claim 11 wherein said alarm comprises a light.

16. The method according to claim 11 wherein said alarm comprises a noise.

17. The method according to claim 11 wherein said alarm comprises an electronic notification.

18. A multiple module manufacturing apparatus capable of detecting module-to-module misalignment, said apparatus comprising:
a first module;
a second module wherein said first and second modules are mechanically fixed to an optimal alignment with respect to each other;
a switch capable of detecting relative motion in a first direction between said first and second modules wherein said relative motion indicates a loss of optimal alignment; and
a means for generating an alarm based on the status of said switch.

19. The apparatus according to claim 18 wherein said apparatus comprises a reticle exposure apparatus for use in the manufacture of an integrated circuit device.

20. The apparatus according to claim 18 wherein said switch comprises a bubble level mechanically coupled to one of said first and second modules and a motion detector coupled to the other of said first and second modules.

21. The apparatus according to claim 18 wherein said switch comprises a mercury switch mechanically coupled to either of said first and second modules.

22. The apparatus according to claim 18 wherein said alarm comprises a light.

23. The apparatus according to claim 18 wherein said alarm comprises a noise.

24. The apparatus according to claim 18 wherein said alarm comprises an electronic notification.

25. The apparatus according to claim 18 wherein said alarm comprises stopping said apparatus.

26. The apparatus according to claim 18 further comprising a second switch capable of detecting relative motion between said first and second modules in a second direction wherein said relative motion indicates a loss of optimal alignment.

27. The apparatus according to claim 26 wherein said second direction is perpendicular to said first direction.
